(19) United States
(12) Patent Application Publication
(10) Pub. No.: US 2019/0009492 A1
(43) Pub. Date: Jan. 10, 2019

(54) DEVICE HAVING A FEED ROLL AND A SELF-ADHESIVE FASTENER, AND ASSOCIATED METHOD AND MACHINE

(71) Applicant: BRICQ, MONTBRON (FR)

(72) Inventors: Raymond GEISS, VOUTHON (FR); Patrick NABOULET, ALLEMANS (FR)

(21) Appl. No.: 16/073,734

(22) PCT Filed: Jan. 26, 2017
(86) PCT No.: PCT/EP2017/051687

§ 371 Date: Jul. 27, 2018

(30) Foreign Application Priority Data
Jan. 27, 2016 (FR) 1650662

(51) Int. Cl. B31F 1/30

(52) U.S. Cl. CPC B31F 1/30

(57) ABSTRACT

A drive device has at least one drive cylinder having an outer surface and at least one cover strip having an inner face and an outer face. The inner face of the cover strip is wound around at least a portion of the outer surface of the drive cylinder. The cover strip is fastened around the drive cylinder by a self-adhesive fastener.

The present invention relates to a drive device comprising at least one drive cylinder having an outer surface and at least one cover strip having an inner face and an outer face, wherein the inner face of the cover strip is wound around at least a portion of the outer surface of the drive cylinder.

Such a device may be used in any type of machine requiring the driving of a strip, a tape, a belt or wire elements.

In particular, such a device is, for example, used in a machine for the production of corrugated board comprising at least one belt. The device drives the belt which, in turn, drives the board.

The cover strip makes it possible, for example, to improve the adhesion between the drive cylinder and the belt by friction between the strip and the belt. Thus, the rotation of the drive cylinder is, completely or almost completely, transmitted to the belt by limiting the loss of movement due to slippage of the strip on the cylinder.

A common technique is to glue cover strips directly on the outer surface of the cylinder.

However, the cover wears out and must be replaced regularly, for example every 1 to 3 years. It is then necessary to peel the cover strips from the cylinder, and then sand the cylinder before gluing on new strips. This process lasts at least two days. Meanwhile, the machine comprising the drive device is stopped. This represents a significant loss for the owner of the machine.

Another technique is to vulcanize rubber directly on the drive cylinder.

When the cover is replaced, it is torn off the drive cylinder which must then be sanded. Finally, rubber is vulcanized again on the cylinder. Similarly, the machine downtime is generally greater than two days.

To reduce machine downtime, WO 2013/044227 discloses a cylinder provided with an interchangeable strip wound around the roll. Two ends of the strip are fastened, for example, by staples.

However, in order that the strip does not slip on the roll, at least one member fixing the strip to the cylinder, for example rivets, is added during the implementation of the device described in WO 2013/044227.

These rivets make it difficult to replace the strip because they must be removed in order to remove the strip. The ends of the new strip must also be fastened.

In addition, between the rivets, the material is likely to form folds around the roll. The quality of the product manufactured by the machine is then likely to be degraded.

An object of the invention is, therefore, to provide a device capable of effectively driving a belt and whose maintenance does not require a long downtime.

To this end, the invention relates to a device of the aforementioned type, characterized in that the cover strip is fastened around the drive cylinder by a self-adhesive fastener.

To replace the cover strip, it is simply removed from the roll with the self-adhesive fastener and a new strip is simply fixed on the cylinder. The time required is thus greatly reduced.

The device according to the invention may comprise one or more of the following characteristics, taken in isolation or in any technically feasible combination:
at least a portion of the outer surface of the drive cylinder and at least a portion of the inner face of the cover strip are fixed to each other by the self-adhesive fastener;
the self-adhesive fastener comprises at least a first strip of self-adhesive material fixed on the outer surface of the drive cylinder and at least a second strip of complementary self-adhesive material fixed on the inner face of the cover strip, wherein the self-adhesive material and the complementary self-adhesive material are able to interact to removably fasten the drive cylinder and the cover strip together;
the cover strip has two ends and a second strip of the self-adhesive fastener is fastened on the inner face at each end of the cover strip, wherein the first strip is fixed on the outer surface of the cylinder, and wherein the first strip interacts with the second strips;
the first strip extends over the entire outer surface of the drive cylinder while the second strip extends over the entire inner face of the cover strip;
the cover strip comprises a first non-slip layer forming the inner face of the cover strip, outside the self-adhesive fastener;
the cover strip comprises a second non-slip layer forming the outer face of the cover strip;
the device comprises a plurality of cover strips, wherein the plurality of cover strips are placed side by side, and wherein each cover strip is wound around a cylindrical portion of the drive cylinder, wherein the outer surface of the drive cylinder and the inner face of each cover strip are fastened to each other by a self-adhesive fastener; and
each cover strip has two ends, wherein the two ends of the different cover strips are not aligned with each other in an axial direction of the drive cylinder.

The invention also relates to a method for placing a cover around a drive cylinder having an outer surface, comprising the following steps:
providing at least one cover strip having an inner face and an outer face,
winding the cover strip around the drive cylinder,
fastening the cover strip around the drive cylinder by a self-adhesive fastener.

The invention also relates to a machine for the production of corrugated board comprising an upper corrugator belt and a lower corrugator belt, wherein the upper and lower corrugator belts each comprise at least one drive device such as described above, wherein the drive cylinder is designed to drive the associated belt, wherein the upper and lower corrugator belts then drive the board between the upper and lower corrugator belts.

The invention will be better understood upon reading the description which follows, given solely by way of example and with reference to the appended figures, wherein:

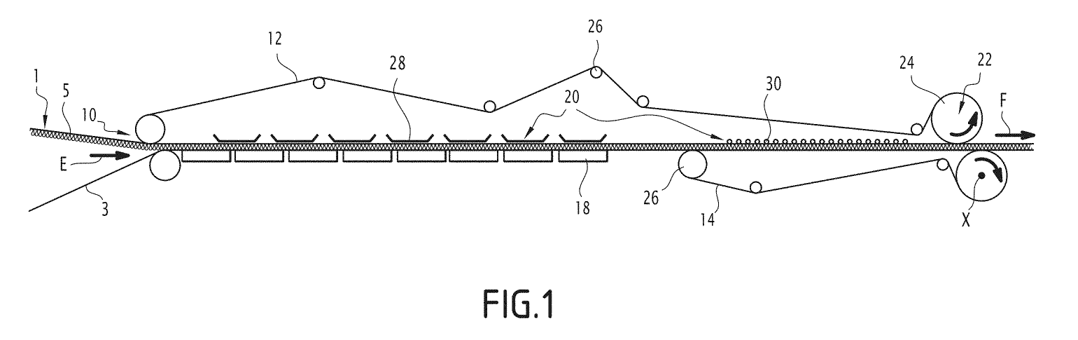

FIG. 1 shows a schematic sectional view of an example of a machine intended for the production of corrugated board,

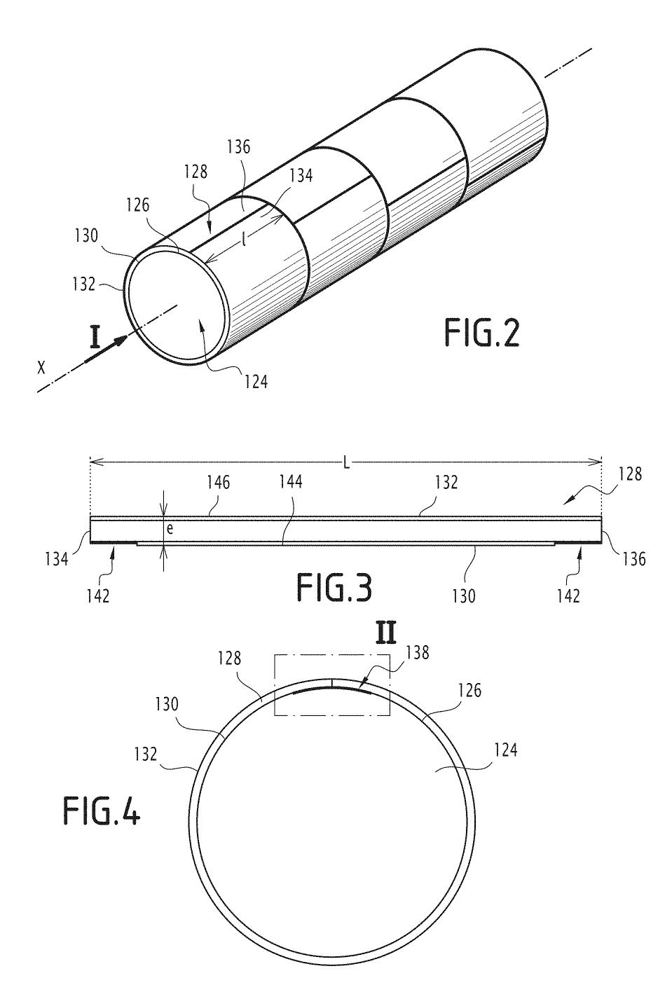

FIG. 2 shows a perspective view of a drive cylinder provided with cover strips of the machine of FIG. 1,

FIG. 3 shows a schematic sectional view of a cover strip of the drive cylinder of FIG. 2 according to a first embodiment,

FIG. 4 shows a diagrammatic view in section I of the drive cylinder provided with the cover strip according to the first embodiment;

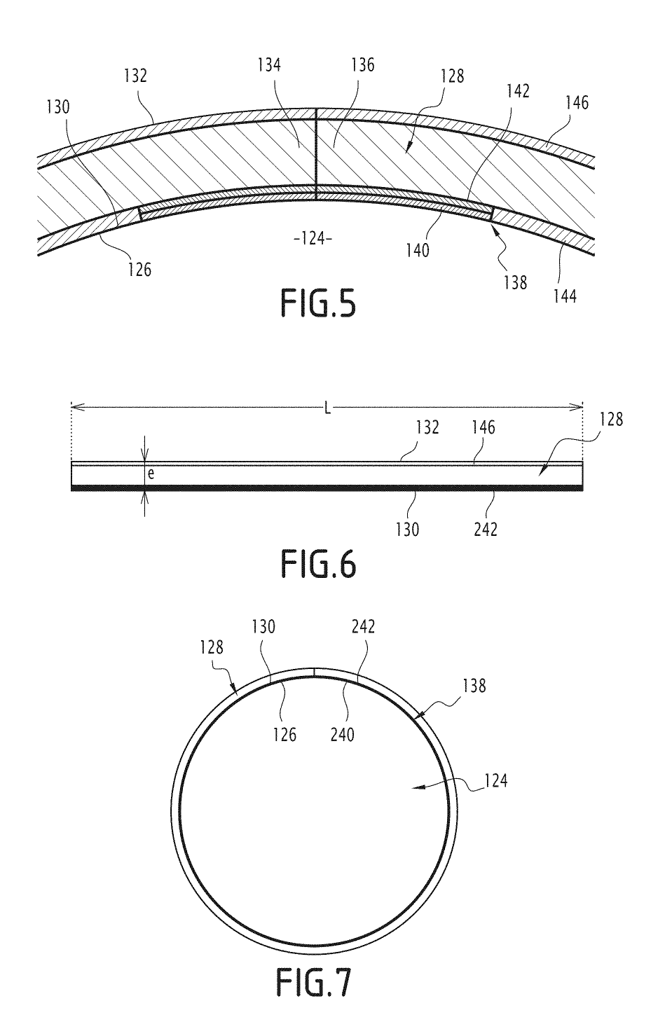

FIG. 5 shows a schematic sectional view of the detail in frame II of FIG. 4,

FIG. 6 shows a schematic sectional view of a cover strip of the drive cylinder of FIG. 2 according to a second embodiment, and

FIG. 7 shows a schematic view in the direction I in section of the drive cylinder provided with the cover strip according to the second embodiment.

A machine 10 for the production of corrugated board 1 is shown in FIG. 1.

It comprises an upper corrugator belt 12 and a lower corrugator belt 14.

It further comprises heating tables 18 and an application system 20.

The machine has a corrugated board production line having a manufacturing direction E, F.

At the start of the production line at the arrow E of FIG. 1, the corrugated board is formed by a first portion 3, comprising a sheet of paper, and a second portion 5, comprising a sheet of paper and a sheet of corrugated paper.

The corrugated sheet is located between the other two sheets of paper.

At the end of the production line, the two sheets of non-corrugated paper and the corrugated sheet between the non-corrugated sheets are integral.

The upper belt 12 extends along the entire production line, above the production line.

The lower belt 14 extends along a portion of the production line, below the production line. This portion is located at the end of the production line according to the direction of production.

This part of the production line is called the pulling part. The carton is pulled by the upper 12 and lower belts 14.

The belts 12, 14 have a width along the production line perpendicular to the direction of production, which is greater than or equal to the desired board width.

The belts 12, 14 are, for example, made of synthetic or natural fiber fabrics, woven or needle punched.

The upper 12 and lower corrugated belts 14 each have a drive device 22, able to drive the associated belt 12, 14, so that the belt moves in the direction of production on the production line.

The upper and lower corrugator belts 12, 14 are thus able to drive the board between the upper and lower corrugator belts 12, 14 in the direction of production F.

Each drive device 22 comprises, for example, at least one drive cylinder 24 and at least one tensioner 26.

The drive cylinder 24 is rotatable in a direction X parallel to the production line and perpendicular to the direction of production E, F.

The drive cylinder 24 will be described in more detail later, with reference to FIG. 2.

The belt 12, 14 surrounds the drive cylinder and the tensioner 26 and links them.

The belt 12, 14 is stretched on the drive cylinder by the tensioner 26.

The drive devices 22 are designed so that the upper and lower belts 12, 14 move at the same speed.

The heating tables 18 extend along a portion of the production line, below the production line. They are located upstream of the lower belt 14 according to the direction of production E, F.

This portion of the production line is called the application portion.

The heating tables 18 are able to heat the board passing over them.

The application system 20 is, in particular, located opposite the heating tables 18 in parallel with the upper belt.

The application system 20 comprises, for example, pads 28 opposite the heating tables 18. The application system 20 is able to press the board against the heating tables 18 and thus, for example, to press the first portion 3 and the second portion 5 of the board between the heating tables 18 and the application system 20, so as to produce corrugated board.

Alternatively, the application system 20 may comprise application rollers in front of the heating tables 18.

In the embodiment shown, the application system 20 comprises, for example, application rollers 30 or pads in the parallel pulling portion of the upper belt 12.

In one embodiment, the upper belt 12 does not extend along the entire production line.

Alternatively, at least one belt is replaced by a plurality of belts.

A drive cylinder 124 provided with at least one cover strip is shown in FIG. 2.

The drive cylinder 124 is mounted in a machine comprising a drive device, for example, in a machine for the production of corrugated board, as described above.

The drive cylinder 124 is a revolving cylinder extending about a main axis X, representing the transverse direction.

The drive cylinder 124 has an outer surface 126.

The cover strip 128 is, for example, made of rubber or fabric.

The cover strip 128 has an inner face 130 and an outer face 132.

The inner face 130 of the cover strip 128 is wound around at least a portion of the outer surface 126 of the drive cylinder 124, in this case around a cylindrical portion of the cylinder.

The cover strip 128 has a first end 134 and a second end 136, wherein the two ends are parallel to each other.

The first end 134 and the second end 136 are in contact when the cover strip is wound around the cylinder 124, so that the entire perimeter of the cylinder is covered by the cover strip.

The flattened strip 128 has, for example, a rectangular shape.

The cover strip 128 has, for example, a thickness e of between 2 mm and 30 mm, preferably between 4 mm and 20 mm. The thickness e is measured as the distance between the inner face 130 and the outer face 132, as shown in FIGS. 3 and 6.

The cover strip 128 has, for example, a width I between 50 mm and 1500 mm, preferably between 250 mm and 350 mm. The width I is measured in the transverse direction when the cover strip 128 is wound around the cylinder, as shown in FIG. 2.

As indicated above, each cover strip 128 has a length L substantially equal to the circumference of the outer surface 126 of the drive cylinder 124. The length L is measured perpendicular to the width, between the first end 134 and the second end 136.

The covering strip 128 is fastened around the drive cylinder 124 by a self-adhesive fastener 138.

According to one embodiment, at least a portion of the outer surface 126 of the drive cylinder 124 and at least a portion of the inner face 130 of the cover strip 128 are attached to each other by the self-adhesive fastener 138.

The self-adhesive fastener 138 comprises at least a first strip 140, 240 of self-adhesive material attached to the outer surface 126 of the drive cylinder 124 and at least a second strip 142, 242 of complementary self-adhesive material attached to the inner face 130 of the cover strip 128.

The self-adhesive material and the complementary self-adhesive material are able to interact in a reversible manner. This allows, in particular, the drive cylinder 124 and the cover strip 128 to be removably fastened together.

The self-adhesive material has, for example, hooks.

The self-adhesive material and the complementary self-adhesive material has, for example, loops.

When the two materials are pressed against each other, the hooks grip the loops and hold the first strip 140, 240 and the second strip 142, 242 together. When pulled in a direction perpendicular to the surface of the material, the links between the hooks and loops unhook, and the hooks and loops return to their original position, allowing them to achieve a new removable fastening.

The adhesion strength is, for example, at least greater than 10 N/cm.

The shear strength is, for example, between 7 and 35 N/cm², and the peel strength between 0.5 and 4 N/cm.

The first and second strips 140, 240, 142, 242 are respectively fixed to the drive cylinder 124 and to the cover strip 128, for example, by gluing.

The glue used has a greater strength than the bond achieved by the hook and loop fastener 138.

The glue has a shear strength greater than 20 N/cm² and a peel strength greater than 5 N/cm.

Thus, the self-adhesive fastener resists tangential forces, especially related to friction with the belt, but the cover strip is removable from the cylinder by an operative, wherein the first and second strips 140, 240, 142, 242 remain attached respectively to the drive cylinder 124 and the cover strip 128.

A first embodiment is shown in FIGS. 3 to 5.

Two second strips 142 are fixed to the inner face 130 of the covering strip 128, wherein a second strip is fastened to each end of the strip 128.

The first strip 140 interacts with the two second strips 142.

The first strip 140 and the second strips 142 have a flat rectangular shape, respectively.

The width of the first strip 140 and the second strips 142, measured in the transverse direction, are equal to each other and to the width of the strip 128.

The length of the first strip 140, measured perpendicular to the width, is substantially equal to the sum of the lengths of each second strip 142.

The second strips 142 have, for example, the same length.

Thus, the first strip 140 and the second strips 142 face each other and are superimposed to form the self-adhesive fastener.

Advantageously, the cover strip 128 comprises a first non-slip layer 144 forming the inner face 130 of the cover strip 128, outside the self-adhesive fastener 138.

The first non-slip layer 144 makes it possible, in particular, to prevent slippage of the cover strip 128 on the cylinder 124 when it is subjected to tangential forces. Such slippage could cause folds of the cover strip 128 to form on the drive cylinder 124. In the case of a machine for the production of corrugated board, folds may cause local defects in the board produced.

Advantageously, the cover strip 128 comprises a second non-slip layer 146 forming the outer face 132 of the cover strip 128.

The second non-slip layer 146 makes it possible, in particular, to improve the frictional adhesion between the cover strip 128 and the rotatably driven element, i.e. in the case of the machine for the production of corrugated board, a belt.

A second embodiment is shown in FIGS. 6 and 7.

The self-adhesive fastener similarly comprises a first strip 240 of self-adhesive material attached to the outer surface 126 of the drive cylinder 124 and a second strip 242 of complementary self-adhesive material attached to the inner face 130 of the cover strip 128.

The first band 240 extends over the entire outer surface 126 of the cylinder 124.

The second strip 242 extends over the entire inner face 130 of the cover strip 128.

Advantageously, as previously, the cover strip 128 comprises a second non-slip layer 146 forming the outer face 132 of the cover strip 128.

A method for placing a cover around a drive cylinder having an outer surface will now be described.

A cover strip as described above, for example according to the first or second embodiment, is provided.

The cover strip is wound around the drive cylinder.

An operator affixes, for example, an end of the inner face of the cover strip against the outer surface of the drive cylinder in the transverse direction.

Then the drive cylinder rotates about its main axis X. The operator holds the cover strip, as it winds around the drive cylinder without forming folds and parallel to the circumference of the drive cylinder.

The drive cylinder and the cover strip are fixed by the self-adhesive fastener.

The cover strip is easily replaceable. An operative removes, for example, the cover strip by pulling on one end in a substantially radial direction. A new cover strip provided with a second strip of complementary self-adhesive material is provided and similarly placed on the drive cylinder.

In the embodiment shown in FIG. 2, the drive device comprises a plurality of cover strips 128 placed side by side, i.e. one next to the other along the transverse direction X, in order to cover the entire drive cylinder.

Two adjacent cover strips 128 are in contact but do not overlap.

The first and second ends 134, 136 of the different cover strips are preferably not aligned in the axial direction of the cylinder X.

This allows, in particular, a better distribution of the forces on the circumference of the cylinder.

Alternatively, the self-adhesive fastener comprises a first strip of self-adhesive material attached to the outer face 132 at the first end 134 of the cover strip 128 and a second strip of complementary self-adhesive material attached to the inner face 130 at the second end 136 of the cover strip 128.

The first end 134 overlaps the second end 136, so that the first strip interacts with the second strip.

The cover strip has a smaller thickness at the first end than the second end, so that when they overlap, the cover strip has a constant total thickness around the cylinder. The cover strip has, for example, a thickness less than half where it is wound upon itself, relative to the rest of the cover strip.

The cover strip has a length greater than the circumference of the drive cylinder over a given distance. The distance corresponds to the overlap of the cover strip.

Advantageously, the cover strip 128 comprises a first non-slip layer forming the inner face of the cover strip, outside the self-adhesive fastener.

Advantageously, the cover strip 128 comprises a second non-slip layer forming the outer face of the cover strip, outside the self-adhesive fastener.

In order to position the cover strip 128 around the cylinder, the second end of the cover strip is affixed against the cylinder, and then the cover strip is wound around the cylinder as a result of the adhesion provided by the first anti-slip adhesive layer. The first end is placed over the second end so that the strips of complementary material interact to form the self-adhesive fastener.

The replacement the cover strip is fast and does not require a long downtime of the machine comprising the drive cylinder.

In addition, the replacement is easily achievable by an operative without requiring the aid of persons specialized in the maintenance of the drive cylinder.

The device according to the invention described above may be used in any type of machine requiring the drive of a strip, a tape, a belt or wire elements.

1. A drive device comprising at least one drive cylinder having an outer surface and at least one cover strip having an inner face and an outer face, wherein the inner face of the cover strip is wound around at least a portion of the outer surface of the drive cylinder,
wherein the cover strip is fastened around the drive cylinder by a self-adhesive fastener.

2. The device according to claim 1, wherein at least a portion of the outer surface of the drive cylinder and at least a portion of the inner face of the cover strip, are fixed to each other by the self-adhesive fastener.

3. The device according to claim 1, the self-adhesive fastener comprises at least one first strip of self-adhesive material attached to the outer surface of the drive cylinder and at least one second strip of complementary self-adhesive material fastened to the inner face of the cover strip, wherein the self-adhesive material and the complementary self-adhesive material are able to interact to removably fasten together the drive cylinder and the cover strip.

4. The device according to claim 3, wherein the cover strip has two ends,
wherein a second strip of the self-adhesive fastener is fastened on the inner face at each end of the cover strip wherein the first strip is fixed to the outer surface of the cylinder, and
wherein the first strip interacts with the second strips.

5. The device according to claim 3, wherein the first strip extends over the entire outer surface of the drive cylinder, while the second strip extends over the inner face of the cover strip.

6. The device according to claim 1, wherein the cover strip comprises a first non-slip layer forming the inner face of the cover strip outside the self-adhesive fastener.

7. The device according to claim 1, wherein the cover strip comprises a second non-slip layer forming the outer face of the cover strip.

8. The device according to claim 1, comprising a plurality of cover strips,
wherein the plurality of cover strips are placed side by side,
wherein each cover strip is wound around a cylindrical portion of the drive cylinder,
wherein the outer surface of the drive cylinder and the inner face of each cover strip are secured to each other by a self-adhesive fastener.

9. The device according to claim 8, wherein each cover strip has two ends,
wherein the two ends of the different cover strips are not aligned in the axial direction of the drive cylinder.

10. A method for winding a cover strip around a drive cylinder having an outer surface, comprising the steps of:
providing at least one cover strip having an inner face and an outer face,
winding the cover strip around the drive cylinder,
fastening the cover strip around the drive cylinder by a self-adhesive fastener.

11. A machine intended for the production of corrugated board comprising an upper corrugator belt and a lower corrugator belt,
wherein the upper and lower corrugator belts each comprise at least one drive device according to claim 1,
wherein the drive cylinder is designed to drive the associated belt,
wherein the upper and lower corrugator belts then drive the board between the upper and lower corrugator belts.
